(19) United States
(12) Patent Application Publication
(10) Pub. No.: US 2002/0112460 A1
(43) Pub. Date: Aug. 22, 2002

(54) Tracked amphibious vehicle with aquatic vegetation shredding assembly

(75) Inventor: David M. Penny, Lawrence, KS (US)

Correspondence Address: HOVEY WILLIAMS TIMMONS & COLLINS, 2405 GRAND BLVD., SUITE 400, KANSAS CITY, MO, 64108

(73) Assignee: THE MASTER'S DREDGING COMPANY, INC.

(21) Appl. No.: 09/790,111

(22) Filed: Feb. 21, 2001

(51) Int. Cl. A01D 44/00

(52) U.S. Cl. 56/8; 56/9

(57) ABSTRACT

A tracked amphibious vehicle with aquatic vegetation shredder includes an amphibious vehicle having a buoyant hull, an endless track supported on the hull, and an aquatic vegetation shredding assembly supported on the hull. The endless track is operable to propel the vehicle on land and through water. These features cooperatively provide a tractional vehicle that is capable of carrying relatively heavier loads than other aquatic vegetation shredders (e.g., the amphibious vehicle can support larger volume shredding assemblies and therefore shred larger volumes of aquatic vegetation than current shredders—up to 5-10 acres per hour). The amphibious vehicle with shredding assembly is particularly effective in shallow water and no water environments (e.g., in and around bodies of water that experience tide conditions and thus have aquatic vegetation growing in shallow water and on dry land). Various alternative configurations of the shredding assembly are disclosed including upright and fore-and-aft shaft orientations for the cutting assembly and a drum and knife cutting assembly.

### BACKGROUND OF THE INVENTION

1. Field of the Invention

The present invention relates generally to equipment for shredding, harvesting, destroying or otherwise processing aquatic vegetation. More specifically, the present invention concerns a tracked amphibious vehicle provided with an aquatic vegetation shredding assembly.

2. Discussion of Prior Art

Aquatic vegetation can be devastating to both marine operations and the aquatic ecosystem. Unfortunately, most conventional expedients are ineffective in destroying or otherwise controlling such vegetation. These problems have previously been identified in our U.S. Letters Patents, both of which are assigned of record to the assignee of the present invention and are identified as follows: U.S. Pat. No. 6,023,920 entitled APPARATUS FOR DESTROYING AQUATIC VEGETATION; and U.S. Pat. No. 6,116,004 entitled AQUATIC VEGETATION DESTROYER.

Our prior inventions address these problems by providing, among other things, a design that is particularly successful in delivering vegetation to the shredding assembly and a design for shredding vegetation both generally at the water surface and well below the water surface to ensure that at least most of the plant is shredded. We have now determined that, in some instances, it would also be beneficial to have an aquatic vegetation shredder that is particularly designed for use in shallow water and in no water conditions (e.g., changes in the water level of a body of water may leave aquatic vegetation growing on dry land).

### OBJECTS AND SUMMARY OF THE INVENTION

Responsive to these and other problems, an important object of the present invention is to provide a device that is capable of eliminating the troubles presented by aquatic vegetation, as noted in our U.S. Letters Patents. It is also an important object of the present invention to provide a machine that is capable of destroying aquatic vegetation in or around shallow water and no water conditions. Another important object of the present invention is to provide an aquatic vegetation shredder that can shred vegetation generally at the water surface as well as below the water surface.

In accordance with these and other objects evident from the following description of the preferred embodiment, the present invention concerns a tracked amphibious vehicle provided with an aquatic vegetation shredding assembly. The amphibious vehicle has a buoyant hull, an endless track supported on the hull, and an aquatic vegetation shredding assembly supported on the hull. The endless track is operable to propel the vehicle on land and through water. These features cooperatively provide a tractional vehicle that is capable of carrying relatively heavier loads than other aquatic vegetation shredders (e.g., the amphibious vehicle can support larger volume shredding assemblies and therefore shred larger volumes of aquatic vegetation than current shredders—up to 5-10 acres per hour). The amphibious vehicle shredder is particularly effective in shallow water and no water environments (e.g., in and around bodies of water that experience tide conditions and thus have aquatic vegetation growing in shallow water and on dry land).

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a top plan view of an aquatic vegetation shredder constructed in accordance with the principles of the present invention, wherein the apparatus comprises a tracked amphibious vehicle supporting an aquatic vegetation shredding assembly;

FIG. 2 is a side elevational view of the machine shown in FIG. 1;

FIG. 3 is an enlarged front cross sectional view of the machine taken generally along line 3-3 of FIG. 2, particularly showing the aquatic vegetation shredding assembly having the generally horizontal cutters mounted on respective upright shafts;

FIG. 4 is an enlarged, fragmentary side view of the stem end of the machine, particularly illustrating the structure for adjustably mounting the propeller to the hull;

FIG. 5 is an enlarged, fragmentary side view of the bow end of the machine, particularly illustrating the primary frame of the shredding assembly swung downwardly to orient the cutters at a forwardly and downwardly sloped angle relative to horizontal;

FIG. 6 is an enlarged, fragmentary side view of the bow end of the machine similar to FIG. 5, but illustrating the cutting assembly swung upwardly relative to the primary frame to reposition the cutters in the horizontal orientation;

FIG. 7 is an enlarged, fragmentary top view of the bow end of a second embodiment of the present invention, wherein the machine includes cutters similar to those shown in FIGS. 1-6 but are rotatable in an upright plane;

FIG. 8 is an enlarged, fragmentary side view of the bow end of the machine shown in FIG. 7 having a portion of the hood removed;

FIG. 9 is an enlarged, fragmentary side view of the bow end of the machine shown in FIG. 7, particularly illustrating the shredding assembly in a lowered position;

FIG. 10 is an enlarged front cross sectional view of the cutting assembly taken substantially along line 10-10 of FIG. 8;

FIG. 11 is an enlarged, fragmentary top view of the bow end of a third embodiment of the invention, wherein the machine includes laterally extending drums carrying multiple flail-type knives;

FIG. 12 is an enlarged, fragmentary side view of the bow end of the machine shown in FIG. 11, with a portion of the frame being removed;

FIG. 13 is an enlarged front elevational view of the cutting assembly taken substantially along line 13-13 of FIG. 12;

FIG. 14 is an enlarged, fragmentary side view of the bow end of the machine shown in FIG. 11, particularly illustrating the shredding assembly in a lowered position; and

FIG. 15 is an enlarged cross-sectional view of the cutting assembly taken substantially along line 15-15 of FIG. 11.

### DETAILED DESCRIPTION OF THE PREFERRED EMBODIMENTS

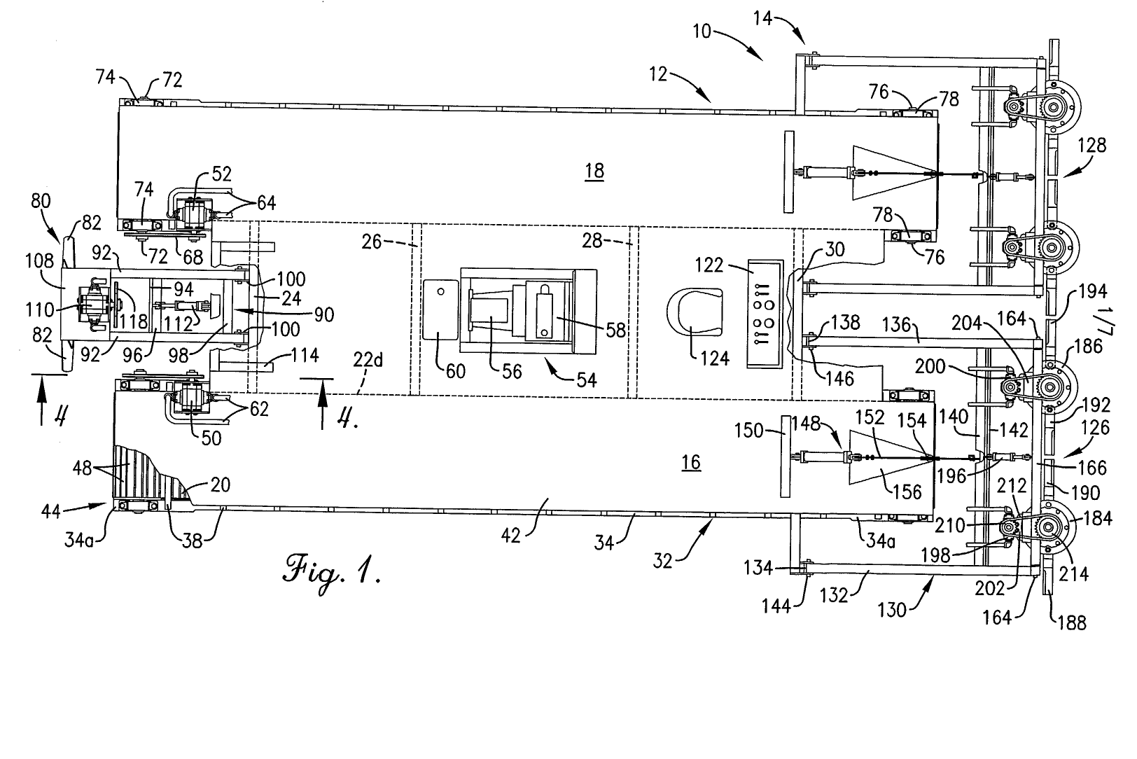

Turning initially to FIG. 1, the aquatic vegetation shredder 10 selected for illustration includes a tracked amphibious vehicle 12 and an aquatic vegetation shredding assembly 14 mounted to the bow end of the vehicle 12. The vehicle 12 includes twin hulls with each hull 16 and 18 being generally identical in construction. For the sake of brevity only the starboard hull 16 will be described in detail, with the understanding that the port hull 18 is similarly constructed. As perhaps best shown in FIGS. 1 and 2, the starboard hull 16 has a pontoon design, with a top wall 20, a bottom wall (not shown), a pair of substantially flat end walls 22a,22b, and a pair of flat, substantially parallel outer and inner side walls 22c and 22d, respectively. The bottom wall has a flat central section and upwardly inclined bow and stem sections. The bow and stem sections of the bottom wall, and the bow and stem ends of the top wall 20 adjoin the respective end walls 22a,22b. The bottom wall and the top wall 20 include channels (not shown) that provide a chain receiving surface for purposes that will subsequently be described.

The side walls 22c and 22d are shaped to correspond to the profile shape formed by the top wall 20, the bottom wall, and the end walls 22a,22b. The side walls 22c,22d project beyond the surface defined by the top wall 20 and the bottom wall. In this manner, well known in the art, the top wall 20, the bottom wall, and the side walls 22c,22d cooperate to provide track receiving lips for purposes which will subsequently be described.

The illustrated amphibious vehicle 12 has an open hull design; that is to say, the hulls 16 and 18 are spaced laterally apart to define a space between the inner side walls. The hulls 16 and 18 are maintained in the spaced apart relationship by cross beams 24,26,28,30 fixed to the top walls.

The cross beams transverse the entire width, generally, of both of the hulls 16 and 18. The cross beam 30 is longer than the beams 24,26,28 and extends beyond each of the outer side walls of the hulls 16 and 18 for purposes that will subsequently be described. In the usual manner, attached to the inner and outer side walls of the hulls 16 and 18 is the decking assembly 32 (see FIG. 2). The decking assembly 32 includes horizontal supports 34, vertical supports 36, lateral supports 38, skirting 40 and decking 42. The horizontal supports 34 are secured to the inner and outer side walls of the hulls 16 and 18. The supports 34 span the entire length of the side walls and widen at the stern and bow ends to form bearing support platforms 34a for purposes that will subsequently be described (see FIG. 1). The lateral supports 38 support the underneath surface of the decking 42 on the vertical supports 36. The vertical supports 36 are configured to provide spacing between the top walls of the hulls 16 and 18 and the lateral supports 38 for reasons that will become apparent. The skirting 40 is positioned between the outer walls of the hulls 16 and 18 and the vertical supports 36. The skirting 40 is fixed to the ends of the cross beams 24,26,28. The cross beam 30 extends through the skirting 40 for purposes that will subsequently be described. The decking 42 provides a flat top surface for supporting various components as will be subsequently described. As shown in FIG. 1, the decking 42 includes cut outs at the bow and stem ends that provide clearance space for various assemblies as described below.

The illustrated vehicle 12 includes an endless starboard track assembly 44 and an endless port track assembly 46 drivingly supported on the hulls 16 and 18, respectively. In one customary manner well known in the art, each assembly 44 and 46 includes track chain rollers (not shown), three strands of heavy duty chain (only the outer chain strand 44a of the starboard assembly 44 and the inner chain strand 46a of the port assembly 46 being shown) and heavy duty forged aluminum alloy track cleats 48. Each strand of the chain is essentially identically constructed therefore only the chain strands 44a,46a will be described in detail. Each of the strands 44a,46a include respective chain links 44b,46b coupled end-to-end (wherein the ends of the links overlap and are off-set relative to the preceding and succeeding links) by the corresponding link pins 44c,46c. The rollers are rotatably coupled to the links 44b,46b by the link pins 44c,46c and are rollably received in the channeled surface of the top and bottom walls. The links 44b,46b have flanged portions (not shown) extending laterally over the channel walls of the channeled surface of the top and bottom walls. The flanged portions of the links 44b,46b sufficiently clear the channel walls so there is no contact therebetween and are coupled to the cleats 48. The cleats 48 of each track assembly 44 and 46 are connected to each of the respective three strands of chains in a similar manner.

The chains, in cooperation with the track chain rollers, are operable to move along the surface of the respective hull in a generally lengthwise direction (i.e., either bow to stem or stem to bow). The cleats 48 are connected to the respective chains so that the cleats 48 lie generally transverse across the chains (i.e., substantially perpendicular to the lengthwise direction). Each of the track assemblies 44 and 46 are operable to be driven over the tracked surface provided by the top and bottom walls of the hulls 16 and 18, respectively. The track assemblies 44 and 46 are received in the track receiving lips formed by the side walls 22c and 22d of the hulls 16 and 18. The spacing provided by the vertical supports 36 allows the track assemblies to be driven around the hulls without interference from the lateral supports 38.

Although the above-noted hull construction is preferred, it is entirely within the ambit of the present invention to utilize various other hull and track designs. For example, the hull design could utilize a single hull configuration or the track design could implement road wheels. However, in any case, it is critical that the buoyant hull is operable to cooperate with structure that provides the vehicle 12 its amphibious qualities.

Each of the track assemblies 44 and 46 is driven by a reversible, variable speed hydraulic motor 50 and 52, respectively. The motors 50 and 52 are mounted adjacent the stem end of the vehicle 12 on the decking 42 above the stem end of the inner side walls of the hulls 16 and 18, respectively. The motors are connected to and powered by a power source 54 (partially shown) via a cab so that the operator controls the speed and direction of the motors as will subsequently be described. In the usual manner, the power source 54 includes a pressurized hydraulic power unit 56 (with a pump), an internal combustion engine 58 drivingly connected to the power unit pump, and a fluid reservoir 60 (See FIG. 2). A suitable engine is available from General Motors Corporation as Model No. ZZ4, rated at 350 horsepower. The unit 56 is connected to the motors 50 and 52 by the fluid circuit lines 62 and 64 (only partially shown), respectively.

The motor 52 includes a drive sprocket 66 mounted on the output shaft of the motor 52 (see FIG. 4). The drive sprocket 66 is entrained by a chain 68 that extends rearwardly and downwardly (through the stem end cut out of the decking 42) to wrap around a driven sprocket 70. The driven sprocket 70 is fixed to a drive shaft 72 rotatably supported on the stem end of the hull 18 by a pair of pillow block bearings 74. The bearings 74 are mounted on the stem end bearing support platforms 34a of the inner and outer horizontal supports 34 of the hull 18. The drive shaft 72 is drivingly connected to the three chains of the track assembly 46 by chain runner sprockets (not shown). The drive shaft 72 is sufficiently spaced from the end walls 22a,22b to provide an open space therebetween to allow debris (e.g., mud) in the track assemblies 44,46 that is loosened by the chain runner sprockets to fall out of the assemblies 44,46 and not get clogged between the shaft 72 and the end walls 22a,22b. In a similar manner (as is well known in the art), the track assembly 46 is further connected to an idler shaft 76. The idler shaft 76 is rotatably supported on the bow end of the hull 18 by a pair of pillow block bearings 78. The bearings 78 are mounted on the bow end bearing support platforms 34a of the inner and outer horizontal supports 34 of the hull 18.

The motor 50 is essentially identical to the motor 52 and is similarly connected to the track assembly 44 by a chain, sprocket drive, and chain runner sprockets. In a manner essentially identical to that described with respect to the track assembly 46, the motor 50 cooperates with drive and idler shafts to drive the track assembly 44, accordingly the starboard side track assembly will therefore not be described in detail.

Those ordinarily skilled in the art will appreciate that amphibious vehicles are commonly operated in both water conditions of varying depths (e.g., deep water and shallow water) and no water conditions. Shallow water and no water conditions often times are associated with sandy terrains (e.g., along shorelines). Although typical amphibious vehicles are designed to operate in these conditions, they experience several difficulties. For example, the tracks of amphibious vehicles tend to wear out faster in sandy conditions. In addition, amphibious vehicles commonly have problems (e.g., losing traction) going from some water conditions into no water conditions (e.g., climbing out of a body of water and onto the shore). Similarly, when amphibious vehicles are completely afloat, the tracks tend to have a limited ability to move the vehicle forward with any rate of speed (e.g., typically one or two miles per hour). It will also be appreciated that aquatic vegetation grows in these varying depth and no water environments. It is therefore desirable for the shredder 10 to be able to effectively operate in these conditions. Accordingly, the shredder 10 is preferably provided with a mechanism for assisting the propulsion of the amphibious vehicle 12 in water conditions and for providing additional comminution of the vegetation (in addition to the comminution provided by the shredding assembly 14 as will subsequently be discussed).

In the illustrated embodiment, this propulsion and comminution mechanism includes a large, high speed propeller 80 rotatably mounted to the amphibious vehicle 12 adjacent the stern end between the hulls 16 and 18. It will be appreciated that the propeller 80 could be mounted further toward the middle of the vehicle 12. The illustrated propeller 80 includes six blades 82 projecting radially from a central hub 84 mounted to a rearwardly extending shaft 86. The propeller blades 82 are preferably fixed at a thirty degree pitch, although a variable pitch propeller may be used, if desired. As shown in FIG. 4, the shaft 86 is journaled by a pair of bearing assemblies 88 and mounted to a swingable propeller frame assembly 90. The frame assembly 90 includes a triangular base section comprising four rearward arms 92 and three transverse arms 94,96,98 (see FIGS. 1 and 4). The triangular base section of the propeller frame assembly 90 is pivotally mounted to the hull cross beam 24 by a pair of bracket assemblies 100. Fixed to the triangular base section of the propeller frame assembly 90 opposite the bracket assemblies 100 is a propeller support section comprising two vertical supports 102, two lateral supports 104, two spacer supports 106, and a knockdown platform 108. The bearing assemblies 88 are supported on the lateral supports 104. The knockdown platform 108 limits the amount of debris and cut vegetation generated from the propeller 80 that is thrown onto the various components located at the stem end of the amphibious vehicle 12. In this regard, it is well within the ambit of the present invention to utilize alternative or additional structure to limit cut vegetation from interfering with the various components (e.g., vegetation shields, chain guards, etc.). The knockdown platform 108 also serves as a motor mount for the hydraulic motor 110 driving the propeller 80. Pivoting of the propeller frame assembly 90 is controlled by a hydraulic piston and cylinder assembly 112 mounted on the decking 42 adjacent the stem end of the vehicle 12. The piston assembly 112 is pivotally mounted to a triangular support assembly 114 and the triangular support assembly 114 is fixed to the decking 42. The piston assembly 112 is operable to extend and retract (as controlled via the cab as will be subsequently discussed) in order to effect pivoting of the propeller frame assembly 90 relative to the hulls 16 and 18. In this manner, the positioning of the propeller 80 relative to the surface of the water is controllably adjustable.

The propeller 80 is driven by the hydraulic motor 110 mounted on the platform 108. The motor 110 is a reversible, variable speed hydraulic motor fluidly connected to the hydraulic power unit 56. In particular, the propeller 80 is drivingly connected to the motor 110 by a chain 116 entraining a drive sprocket 118 supported on the output shaft of the motor 110 and a relatively larger driven sprocket 120 supported on the propeller shaft 86. The motor 110 is preferably controlled from the cab 122 so that the operator can easily control the speed and direction of the propeller 80. The cab 122 is located toward the bow end of the decking 42 of the amphibious vehicle 12. Adjacent the cab 122 is an operator's seat 124. It will be appreciated that each of the hydraulic motors 50,52,110 (as well as the motors for driving the shredding assembly 14 discussed below) are preferably controlled from the cab 122 (e.g., by connecting each of the motors to the power source 54 via a controller located in the cab 122) to enable the operator to easily control all of the various motors. It will further be appreciated that all of the various motors are fluidly connected to the hydraulic unit 56 by respective similarly configured fluid lines (partially shown). In the illustrated shredder 10, the various hydraulic motors are powered by a single power source 54. However, it is within the ambit of the present invention to utilize multiple power sources (e.g., a power source powering the track motors and a separate power source powering the remaining motors). It is also within the ambit of the present invention to include alternative variously constructed propulsion means (e.g., multiple propellers, bow mounted propeller, an outboard engine, etc.) so long as the propulsion means provide the vehicle with amphibious capabilities.

Those ordinarily skilled in the art will appreciate that the illustrated amphibious vehicle 12 is similar in many respects to standard amphibious vehicle constructions. It is therefore within the ambit of the present invention to utilize a commercially available amphibious vehicle and make any necessary modifications to it. A suitable vehicle is available under the designation CARGO BUGGY from Marsh Buggies, Inc., Lou-Ark Division, of Harvey, La. It has particularly been determined that the 28′6″×16′ Model No. CB 251645 is well suited for use in the illustrated embodiment.

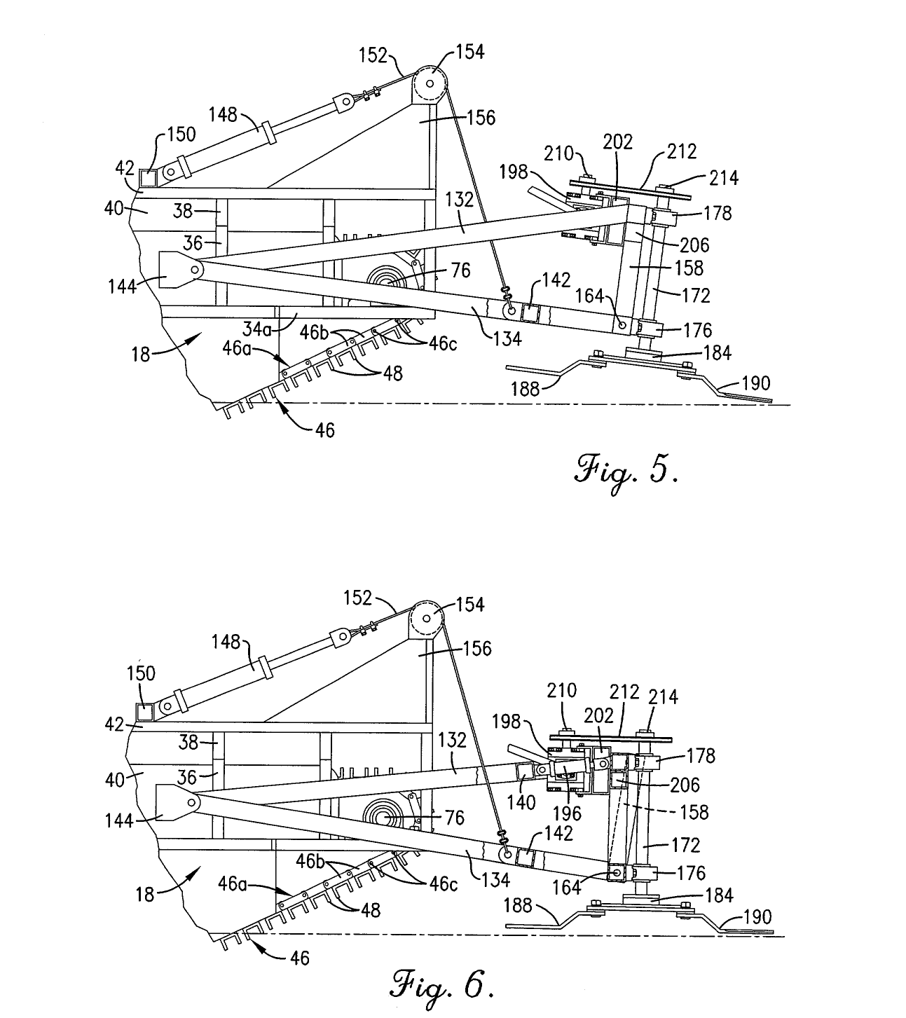

The aquatic vegetation shredding assembly 14 is mounted to the vehicle 12 at the bow end. The shredding assembly 14 includes a pair of cutting assemblies, a starboard assembly 126 and a port assembly 128. The cutting assemblies 126 and 128 are nearly identical in construction. Thus, for the sake of brevity, only the starboard cutting assembly 126 will be described in detail herein with the understanding that the port assembly 128 is similarly constructed. In particular, a frame 130 is swingably mounted to the vehicle 12 and includes a starboard pair of fore-and-aft arms 132 and 134 and a port pair of fore-and-aft arms 136 and 138. As shown in FIG. 2, the starboard pair of arms 132 and 134 are joined at their rearward ends and form two sides of a triangle. The port pair of arms 136 and 138 are similarly configured. The starboard and port pairs of arms are fixedly connected by transverse bars 140 and 142 (see FIGS. 1 and 6). Transverse bar 142 is fixed between fore-and-aft arms 134 and 138 adjacent their forward ends. Transverse bar 140 is fixed between fore-and-aft arms 132 and 136 adjacent their forward ends. The starboard and port pairs of arms are pivotally attached to the hull 16 by bracket assemblies 144 and 146 respectively. The bracket assemblies 144 and 146 are mounted on the cross beam 30. As previously described, the cross beam 30 extends beyond the outer side wall 22c of the hull 16. This configuration provides clearance so the bracket assembly 144 can be mounted on the beam 30 wherein the starboard pair of fore-and-arms 132 and 134 are disposed outwardly from the hull 16 so as to permit swinging of the frame 130 below the decking 42. Perhaps as best shown in FIG. 5, swinging of the frame 130 is controlled by a double-acting hydraulic piston and cylinder assembly 148 pivotally mounted to the cylinder support bar 150. The cylinder support bar 150 is mounted to the decking 42. A cable 152 is connected between the hydraulic assembly 146 and the transverse bar 142, such that the frame 130 swings downwardly as the assembly 148 extends, and the frame 130 swings upwardly as the assembly 148 retracts. It will be noted that the cable 152 partially entrains a pulley 154 rotatably mounted to the hull 16 by a stand 156.

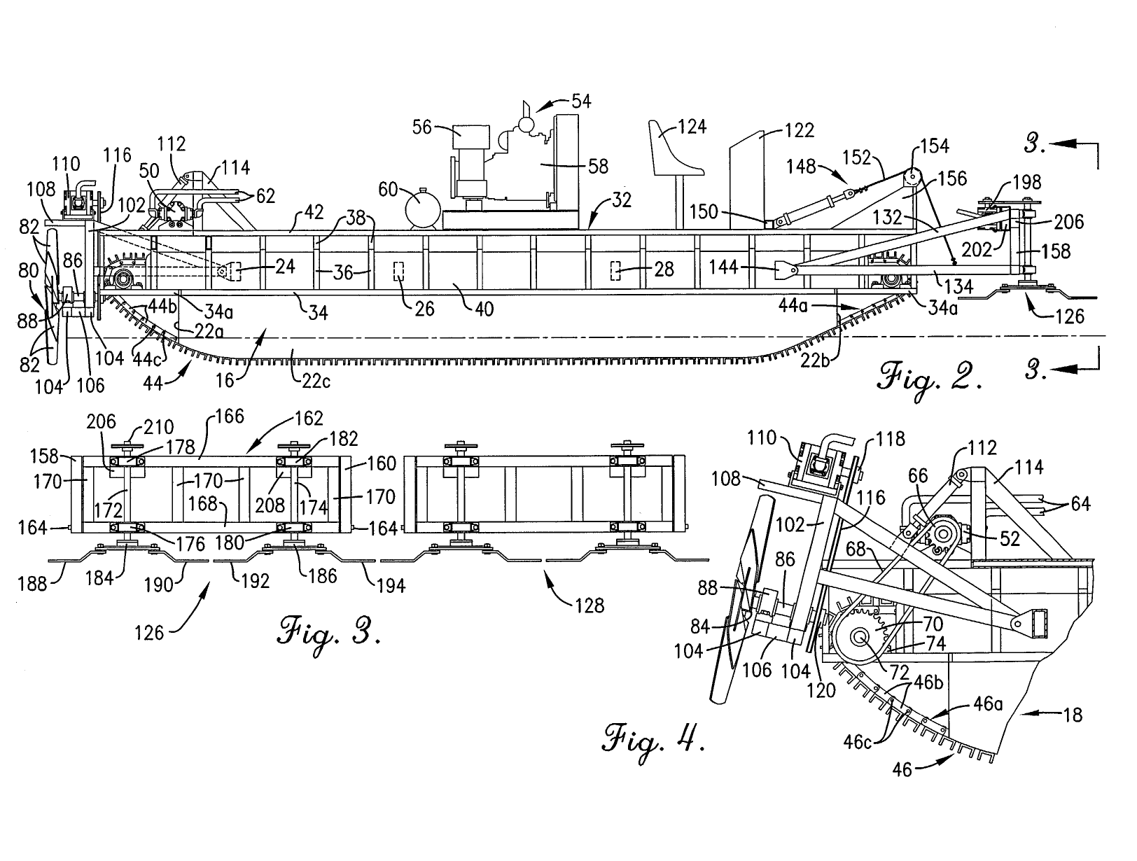

As previously described, the starboard arms 132 and 134 form two sides of a triangle (as do the port arms 136 and 138). Attached to the forward ends of the starboard and port arms, completing the triangle, are the end arms 158 and 160. Pivotally mounted to the frame 130, between the end arms 158 and 160, is a cutter assembly 162 (see FIGS. 1 and 2). The cutting assembly 162 is pivotally mounted to the frame 130 on pivots 164. As shown in FIG. 3, the assembly 162 includes an upper horizontal support member 166, a downwardly spaced lower horizontal support member 168, and vertical support members 170. Rotatably coupled to the assembly 162 are upright shafts 172 and 174. The shafts 172 and 174 are each rotatably supported on the horizontal support members 166 and 168 by a pair of pillow block bearings 176,178 and 180,182, respectively. Rigidly fixed to the lower end of each of the shafts 172 and 174 is a corresponding hub 184 and 186. Swingably mounted to each of the hubs 184 and 186 are a plurality of cutting blades 188,190 and 192,194, respectively. The blades 188,190,192,194 are each bolted to the corresponding hub 184 or 186 so that when the hub 184 or 186 rotates, they project in a generally radial orientation (as shown in FIG. 1); however, they are deflectable out of the general radial orientation. That is, if the blade 188, for example, strikes a rigid object (relative to the typical vegetation being shredded) such as a tree trunk, the blade 188 parries off the trunk. It is believed this mounting configuration prevents the blades 188,190,192,194 from becoming prematurely deformed and worn thereby extending the overall life of the cutter assembly 162. The blades 188,190,192,194 are pitched such that shredded vegetation is lifted away from the corresponding blade once cut. Because lifted vegetation may fall onto the shafts 172 and 174 and into the vehicle 12, the shredding assembly 14 includes a vegetation shield (not shown) fixed to and extending along the face of the cutter assembly 162 and fixed to and extending between the bottom of arms 132 and 136 along the portion thereof that extends beyond the hull 16. The vegetation shield is designed to limit the amount of cut vegetation that falls against the shafts 172 and 174 and back into the vehicle 12. The vegetation shield may be variously constructed and utilize alternative materials and designs (e.g., a rubber matting tied to the primary frame with rope).

Pivoting of the assembly 162 is controlled by a hydraulic piston and cylinder assembly 196 pivotally mounted between the transverse bar 140 and the upper horizontal member 166 (see FIGS. 1 and 6). In its unactivated position as shown in FIG. 5, the cylinder assembly 196 maintains the cutter assembly 162 vertically alligned and generally parallel with the end arms 158 and 160. As the cylinder assembly 196 retracts from the unactivated position, the cutter assembly 162 pivots toward the position shown in FIG. 6. In this way, the cutter assembly 162 can be pivotally adjusted in order to achieve the desired positioning of the cutting blades 188,190,192,194 relative to the surface of the water (or the ground). For example, as shown in FIG. 6, the cutting blades 188,190,192,194 are generally parallel to the surface of the water (designated by the dashed line). Although not shown, it will be appreciated that the cylinder assembly 196 may be extended, rather than retracted, from the unactivated position shown in FIG. 5 thereby causing the cutter assembly 162 to pivot away from the position shown in FIG. 6. It will be appreciated that the cutter assembly 162 can be positioned (via assemblies 148 and 196) to shred aquatic vegetation located below the surface of the water (e.g., root structures).

Each of the upright shafts 172 and 174 is driven by a reversible, variable speed hydraulic motor 198 and 200, respectively, mounted to the stern side of the assembly 162 on the corresponding motor mount 202 and 204. The motor mounts 202 and 204 are each rigidly fixed to the upper horizontal member 166 and to a corresponding motor mount support 206 and 208. The motor 198 is connected to and powered by the power unit 56. A drive sprocket 210 mounted on the output shaft of the motor 198 is entrained by a chain 212 that extends forwardly to wrap around a driven sprocket 214 fixed to the shaft 172. The shredding assembly 14 further includes chain guards (not shown) mounted to the cutting assembly 162 that prevent shredded debris from falling in and around the chains. The motor 198 preferably rotates the shaft 172 (and the attached blades 188 and 190) in a clockwise direction when viewed from above, as in FIG. 1. The motor 200 is essentially identical to the motor 198 and similarly connected to the shaft 174 by a chain and sprocket drive. However, the motor 200 is preferably linked to the motor 198 so that the shaft 174 (and the attached blades 192 and 194) rotates in the same direction as the shaft 172 (i.e., preferably a clockwise direction when viewed from above, as in FIG. 1). It is believed that with the shafts 172 and 174 configured to rotate in the preferred direction, the shredded vegetation is thrown away from the center of the vehicle 12, as is desirable. The motors 198 and 200, however, are reversible thereby allowing for selective and varied rotation of the shafts 172,174. The principles of the present invention equally apply to vegetation shredders that utilize alternative forms of directing the cut vegetation away from the center of the vehicle 12. It is also entirely within the ambit of the present invention to utilize a single cutter rather than multiple cutters as illustrated.

As previously discussed, the port cutting assembly 128 is essentially identical to the starboard cutting assembly 126. However, the port assembly 128 is configured to rotate the respective shafts in the opposite direction of rotation relative to the shafts 172,174 (i.e., in the preferred embodiment, the shafts of the assembly 128 would rotate counterclockwise when viewed from above, as in FIG. 1). Again, it is believed this configuration throws the shredded vegetation away from the center of the vehicle 12. It is within the ambit of the present invention to utilize a single cutting assembly rather than multiple cutting assemblies as illustrated. However, it is believed that multiple cutting assemblies are optimal where the width of the amphibious vehicle exceeds eight feet to limit the occurrence and effects of bent shafts.

Many forms of aquatic vegetation grow in shallow water conditions and in no water conditions (e.g., in and around the shoreline area of bodies of water that experience either tide conditions or decreases in water levels). It is desirable, therefore, to have aquatic vegetation shredders that have the ability to operate in such conditions. It is also desirable to have an aquatic vegetation shredder with the capacity to shred large amounts of vegetation in a single pass (e.g., relatively wide cutting zones). Accordingly, in use, the illustrated aquatic vegetation shredder 10 is designed for shredding a high volume of vegetation growing in various environments such as various water depths or no water conditions. The operator seated in the seat 124 operates the controls of the cab 122 to engage the track motors 50 and 52 to drive the track assemblies 44 and 46, respectively. The tracks 44 and 46 propel the amphibious vehicle 12 through the water (as it floats on the hulls 16 and 18) and/or over land (as it is supported on the tracks 44 and 46). The operator engages the cutter motors 198 and 200 to rotate the cutter blades 188,190,192,194. The operator activates the cylinder assemblies 148 and 196 to adjust the frame 130 and the cutter assembly 162, respectively to the desired blade orientation relative to the surface (e.g., generally parallel to the surface if “mowing” vegetation in water or on land, or angled below the surface if cutting root structures).

The vehicle 12 moves in a forward direction shredding vegetation in its path with the shredding assembly 14. The operator engages the propeller motor 110 to rotate the propeller 80 and activates the cylinder assembly 112 to pivotally adjust the propeller frame assembly 90 thereby adjusting the orientation of the propeller blades 82 relative to the surface (e.g., to avoid contact of the blades 82 with the surface in shallow or no water conditions). The propeller 80 assists in propelling the vehicle 12 along its forward (or reverse) path and provides additional commination of the vegetation. The operator can stop or reverse any motor at any time, for example, the tracks can be rotated in opposite directions to perform a short radius turn or the cutter motors can be reversed to assist in “pushing” the vehicle backwards out of a low traction area.

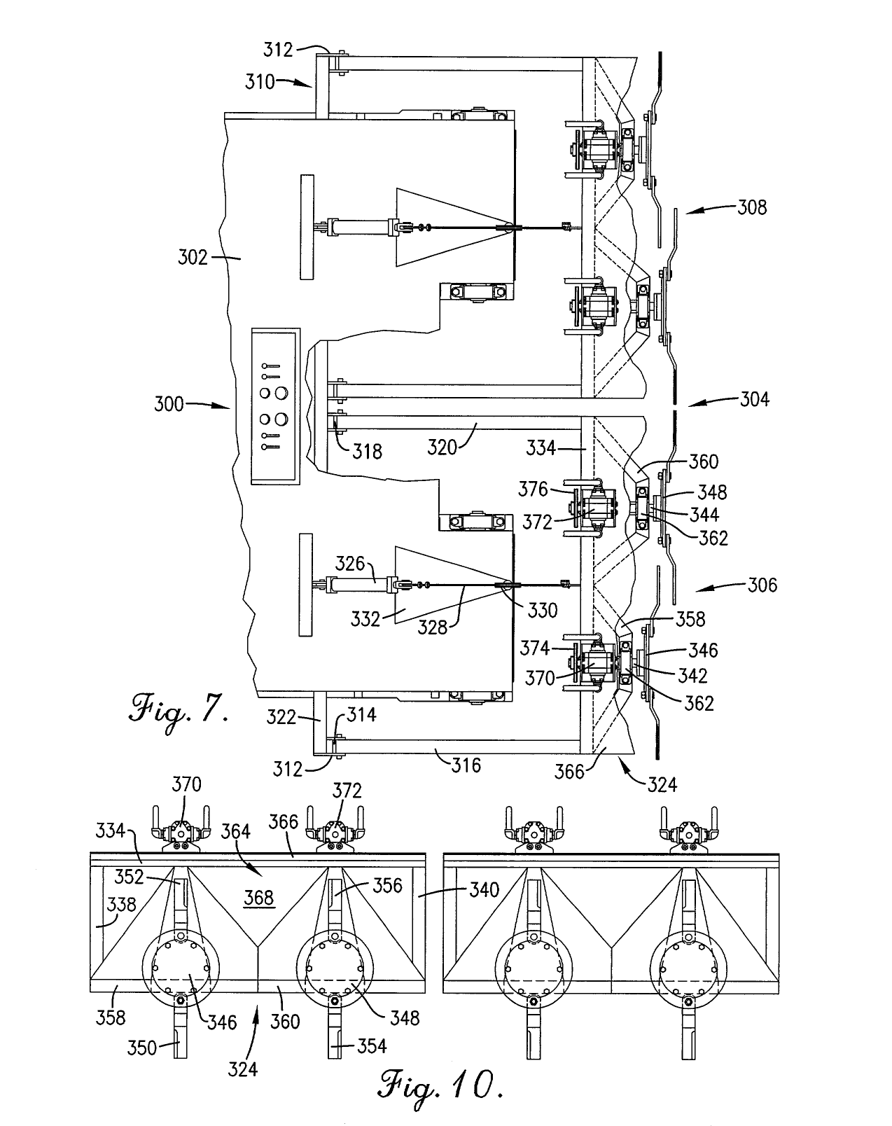

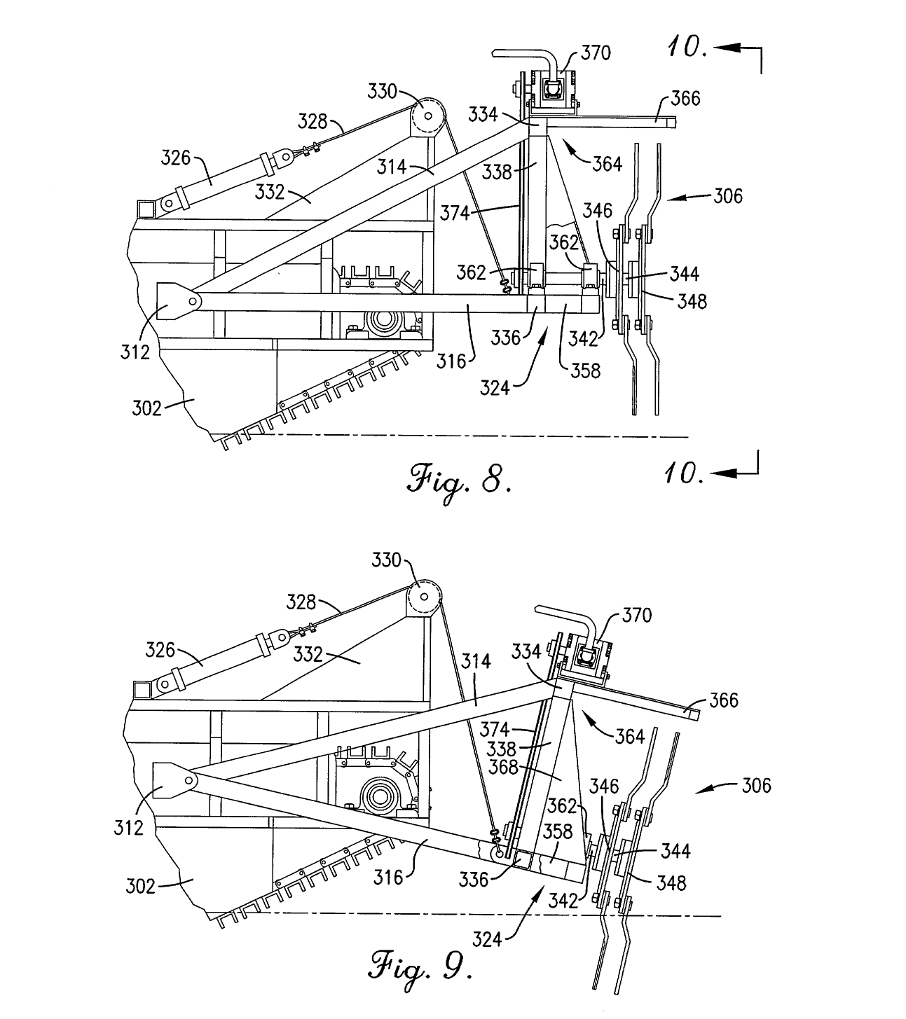

As previously discussed, the principles of the present invention are equally applicable to various other shredding assembly constructions. One such variation is illustrated in FIGS. 7-10, as an aquatic vegetation shredder 300 including an amphibious vehicle 302 and an aquatic vegetation shredding assembly 304 mounted to the bow end of the vehicle 302. The shredder 300 is generally similar to the machine 10 shown in FIGS. 1-5; however, the cutters of the shredding assembly 304 are disposed in a generally vertical plane and are rotatable about fore-and-aft axes. It will be appreciated that the vehicle 302 is substantially similar to the vehicle 12 and therefore the vehicle 302 will not be described further herein. In a similar manner, the shredding assembly 304 is constructed in a somewhat similar manner as the shredding assembly 14 and therefore the similar features of the assembly 304 will only be briefly discussed. The shredding assembly 304 includes a pair of cutting assemblies, a starboard assembly 306 and a port assembly 308. The cutting assemblies 306 and 308 are nearly identical in construction. Thus, for the sake of brevity, only the starboard cutting assembly 306 will be described in detail herein with the understanding that the port assembly 308 is similarly constructed. The assembly 306 is swingably mounted to the vehicle 302 by a frame 310 pivotally mounted on bracket assemblies 312. The frame 310 includes starboard fore-and-aft arms 314 and 316, port fore-and-aft arms 318 and 320, and transverse bar 322 (see FIGS. 7 and 8). The cutting assembly 306 includes a cutter assembly 324; unlike the cutting assembly 162, cutting assembly 324 is rigidly fixed to the frame 310 thereby obviating the need for end arms, any pivot-enabling structure, and multiple transverse bars. Similar to cutting assembly 126, swinging of the frame 310 is controlled by a piston and cylinder assembly 326, including a cable 328, a pulley 330 and a stand 332; however, the cable 328 is fixed to the cutter assembly 324 rather than a transverse bar (see FIG. 9).

The cutter assembly 324 includes upper and lower horizontal support members 334 and 336, and vertical support members 338 and 340 (see FIG. 8). Similar to the cutter assembly 162, the cutter assembly 324 includes shafts 342 and 344, hubs 346 and 348, and swingable cutting blades 350,352,354,356. The blades 350,352,354,356 are configured like the blades 188,190,192,194 so they project in a generally radial orientation and are deflectable out of the general radial orientation. Unlike the upright shafts 172 and 174, the shafts 342 and 344 have a fore-and-aft orientation (see FIG. 7). In order to accommodate the fore-and-aft orientation, assembly 324 includes lateral support members 358 and 360, each having a three-sided configuration and being fixed to the lower horizontal support member 336 (see FIG. 7). The port-side lateral support member 360 extends forwardly from the bow end of the vehicle 302 a further distance than does the starboard-side lateral support 358 in order to support the longer length of the shaft 344 relative to the shaft 342 for reasons that will be described below. Each of the shafts 342 or 344 is rotatably supported on the lower horizontal support 336 and the corresponding lateral support 358 or 360 by a respective pair of pillow block bearings 362. The cutting assembly 324 includes a vegetation shield assembly 364. The shield assembly 364 includes a knockdown plate 366 rigidly coupled to the upper horizontal support 334 and extending forwardly therefrom. The shield assembly 364 further includes a hood 368 extending outwardly and downwardly from the upper horizontal support 334 and adjoining the lateral support members 358 and 360 (see FIGS. 9 and 10). The plate 366 and the hood 368 form a vegetation barrier between the cutting area defined by the blades 350,352,354,356 and the vehicle 302, when the cutting assembly 306 is in operation. It is believed this configuration enhances the cutting action of the assembly 306.

Similar to the cutting assembly 126, the cutting assembly 306 is powered by a hydraulic power source (not shown) that drives hydraulic motors 370 and 372. The motors 370 and 372 are mounted to the top of the knockdown plate 366 and have output shafts configured to accommodate the fore-and-aft orientation of the shafts 342 and 344. That is, the motors 370 and 372 are drivingly connected to the shafts 342 and 344 by the corresponding chains 374 and 376 that extend downwardly to the shafts 342 and 344. The motors 370 and 372 are operable to rotate the shafts 342 and 344 in varied directions such that the rotational direction of the shafts 342 and 344 can be the same or the opposite direction relative to each other. As previously discussed, the axial length of the shaft 344 is longer than the axial length of the shaft 342. This configuration provides for offset rotational planes of the blades 350 and 352 relative to the blades 354 and 356. As shown in FIG. 7, a portion of the blades 350 and 352 (when rotating) will overlap a portion of the blades 354 and 356 (when rotating); however, the offset rotational planes of the cutters prevents blade contact. It is believed this overlapping relationship allows for the maximum amount of cut vegetation to be directed away from the center of the vehicle 302 as is desirable. As previously discussed, unlike the cutter assembly 162, the cutter assembly 324 is rigidly (not pivotally) fixed to the frame 310 and repositioning of the cutter assembly 324 can consequently be effected only by swinging the frame 310. Depending on the conditions, it is believed that the cutting blades 350,352,354,356 need not be directly perpendicular to the surface of the water (or ground) in order to provide the desired shredding of aquatic vegetation. As shown in FIGS. 8 and 9, swinging of the frame 310 adjusts the orientation of the cutter assembly 324 so that shredding of the vegetation can occur at, above or below the surface.

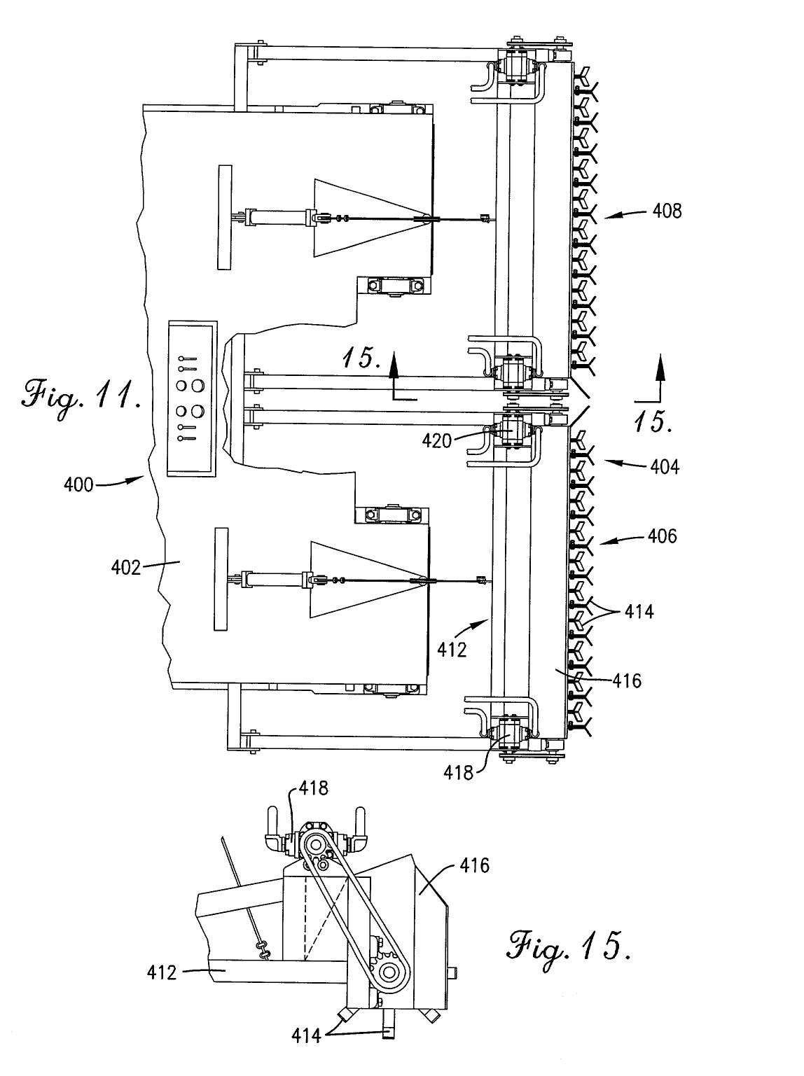

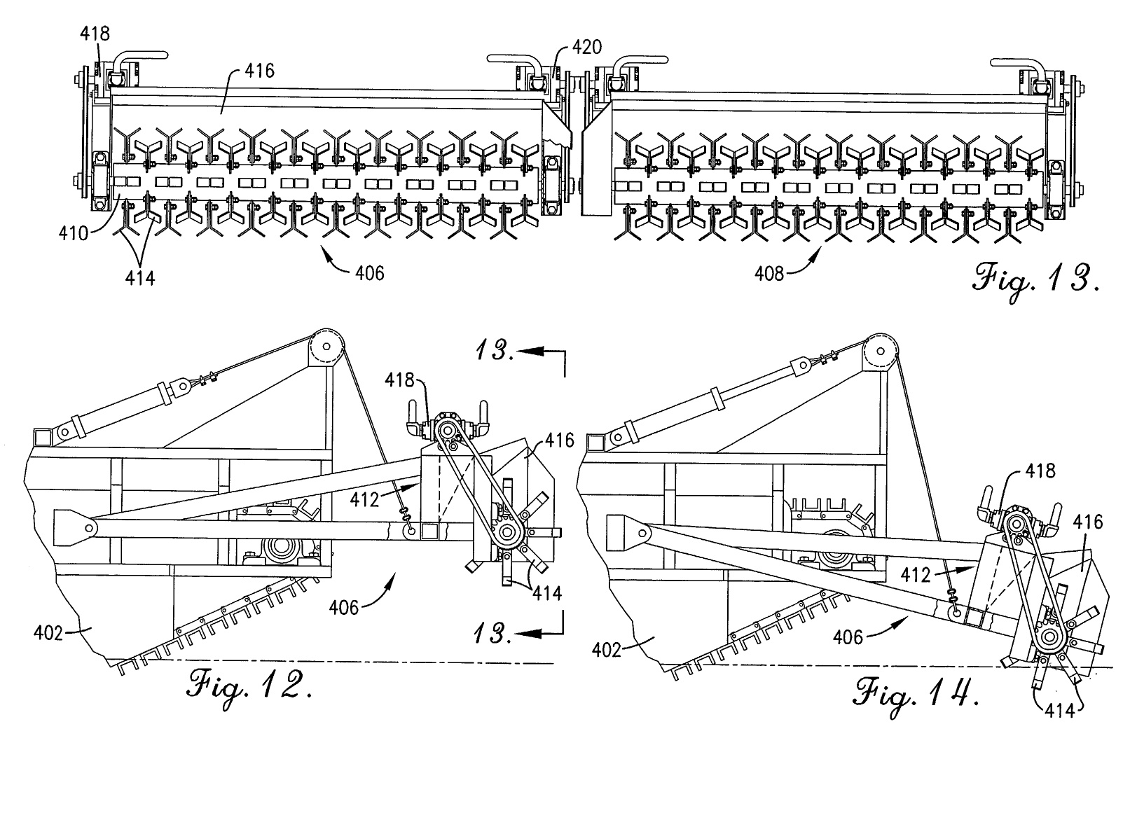

Another variation of the shredding assembly is embodied in the aquatic vegetation shredder 400, as illustrated in FIGS. 11-15. The shredder 400 includes an amphibious vehicle 402 and an aquatic vegetation shredding assembly 404 mounted to the bow end of the vehicle 402. It will be appreciated that the only significant difference between the shredder 400 and the shredder 300 shown in FIGS. 7-10 is the starboard and port cutting assemblies 406 and 408, respectively. The cutting assemblies 406 and 408 are nearly identical in construction. Thus, for the sake of brevity, only the starboard cutting assembly 406 will be described in detail herein with the understanding that the port assembly 408 is similarly constructed. The assembly 406 includes a drum 410 rotatably supported on a support assembly 412, a plurality of knives 414 swingably supported on the drum 410, and a vegetation shield 416. A similar arrangement is disclosed in our U.S. Pat. No. 6,116,004, entitled AQUATIC VEGETATION SHREDDER, which is hereby incorporated by reference herein as is necessary for a full and complete understanding of the present invention. The cutting assembly 406 is powered by a hydraulic power source (not shown) and two end-mounted hydraulic motors 418 and 420. The motors 418 and 420 are operable to selectively rotate the drum 410 in either a clockwise direction or a counterclockwise direction relative to the axis of rotation.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. An aquatic vegetation shredder comprising:
an amphibious craft including a buoyant hull and an endless track supported on the hull and operable to propel the craft on land and through water; and
an aquatic vegetation shredding assembly supported on the hull.

2. An aquatic vegetation shredder as claimed in claim 1,
said craft including an additional buoyant hull and an additional endless track supported on the additional hull,
said additional hull being laterally spaced from the first-mentioned hull such that a channel is defined there between.

3. An aquatic vegetation shredder as claimed in claim 2,
said shredding assembly being positioned generally ahead of the bow end of the craft; and
a propeller rotatably mounted to the craft at least generally adjacent the stem end, said propeller being operable to propel the craft through the water.

4. An aquatic vegetation shredder as claimed in claim 3,
said propeller being positioned adjacent the channel defined between the hulls,
said propeller being vertically adjustable relative to the craft,
said propeller being operable to chop aquatic vegetation.

5. An aquatic vegetation shredder as claimed in claim 1,
said aquatic vegetation shredding assembly including a frame, a shaft rotatably supported by the frame, and a vegetation shredding blade coupled to the shaft,
said shaft being positioned generally ahead of the bow end of the craft.

6. An aquatic vegetation shredder as claimed in claim 5,
said shaft being rotatable about an upright axis.

7. An aquatic vegetation shredder as claimed in claim 6,
said shaft being pivotally supported on the frame so that the orientation of the upright axis may be varied.

8. An aquatic vegetation shredder as claimed in claim 7,
said frame being swingably mounted on the hull,
said shredding blade being swingably coupled to the shaft.

9. An aquatic vegetation shredder as claimed in claim 6,
said frame being swingably mounted on the hull,
said aquatic vegetation shredding assembly including an additional shaft spaced laterally from the first-mentioned shaft and an additional vegetation shredding blade coupled to the additional shaft,
each shaft being rotatable independent of the other shaft.

10. An aquatic vegetation shredder as claimed in claim 9,
said craft including an additional buoyant hull spaced laterally from the first-mentioned hull and an additional endless track supported on the additional hull; and
an additional aquatic vegetation shredding assembly supported on the additional hull.

11. An aquatic vegetation shredder as claimed in claim 5,
said shaft being rotatable about a fore-and-aft extending axis.

12. An aquatic vegetation shredder as claimed in claim 11,
said frame being swingably mounted on the hull,
said aquatic vegetation shredding assembly including an additional shaft spaced laterally from the first-mentioned shaft and an additional vegetation shredding blade coupled to the additional shaft,
each shaft being rotatable independent of the other shaft.

13. An aquatic vegetation shredder as claimed in claim 12,
the first-mentioned and additional blades being rotatable in relatively offset planes,
said rotating blades presenting overlapping portions.

14. An aquatic vegetation shredder as claimed in claim 12,
said craft including an additional buoyant hull spaced laterally from the first-mentioned hull and an additional endless track supported on the additional hull; and
an additional aquatic vegetation shredding assembly supported on the additional hull.

15. An aquatic vegetation shredder as claimed in claim 1,
said aquatic vegetation shredding assembly including a frame, a drum rotatably supported by the frame, and a plurality of knives swingably mounted to the drum.

16. An aquatic vegetation shredder as claimed in claim 15,
said knives being arranged in rows spaced along the length of the drum, with each of said rows including a pair of said knives mounted to the drum at diametrically opposite locations.
